(19) United States
(12) Patent Application Publication
(10) Pub. No.: US 2013/0186837 A1
(43) Pub. Date: Jul. 25, 2013

(54) Method and Kit for Reducing Cyanuric Acid Levels in Pool Water

(71) Applicant: Dana William Somesla, Riverside, CA (US)

(72) Inventor: Dana William Somesla, Riverside, CA (US)

(73) Assignee: KIK Custom Products Inc., Concord (CA)

(21) Appl. No.: 13/357,068

(22) Filed: Jan. 24, 2012

(51) Int. Cl. C02F 9/04; C02F 5/12; C02F 103/42

(52) U.S. Cl. 210/719; 252/176

(57) ABSTRACT

A method and kit is provided for reducing cyanuric acid levels in pool water comprising the steps of adding a reducing agent to remove substantially all of the chlorine from the water, adding a source of melamine to react with the cyanuric acid to form melamine cyanurate, and removing the precipitated melamine cyanyurate. Following completion of the method, the pool water is then re-chlorinated. The application of this method addresses the “green water” problem typically associated with the removal of cyanuric acid from swimming pools with melamine.

### FIELD OF THE INVENTION

The present invention relates to an improved method and kit for reducing the concentration of cyanuric acid (CYA) in water, in particular swimming pool water, using melamine and a reducing agent.

### BACKGROUND OF THE INVENTION

Chlorine, which is commonly used as an antimicrobial/anti-algae agent in swimming pools, is degraded by UV light. As a result, a chlorine stabilizer, such as CYA is commonly added to pool water to assist in maintaining chlorine levels by prolonging the lifetime of chlorine in the water, thereby reducing the amount of chlorine that needs to be added to a pool. CYA is believed to protect or stabilize chlorine in water by binding with it and absorbing the UV light rays (sunlight) that would otherwise rapidly degrade the chlorine to sodium chloride. Commonly used stabilized chlorine products, such as dichlor and trichlor, contain both a chlorine source and CYA. However, unlike chlorine, CYA is not rapidly consumed over time. Thus, the use of such products means that, over time, CYA levels in the pool gradually increase above acceptable limits (generally the acceptable limit is no more than 70-100 ppm, although some regulators are attempting to lower this limit to 50 ppm), a result of which is that there may be insufficient free chlorine (i.e., chorine not bound to CYA) to provide its necessary antimicrobial effect. When this situation, commonly referred to as “chlorine lock”, occurs (typically around 100 ppm CYA), the addition of further chlorine is ineffective and microbial growth is able to proliferate. Therefore, once the CYA levels in a pool exceed acceptable limits, it is necessary to lower the CYA concentration of the pool water.

One method used to reduce CYA levels in pools is simply to replace a large volume of the pool's water. However, this method is both time consuming and costly given that for commercial-sized pools the volume of water to be replaced can amount to 25-50% of the pool capacity, resulting in thousands of gallons of water being removed each time the CYA concentration exceeds desired levels. In addition to the time and cost involved, this approach is often unavailable in areas where, or times when, water is not abundantly available, particularly when local agencies are enforcing regulations as a result of existing local drought conditions.

As an alternative to replacing pool water, U.S. Pat. No. 4,793,935 describes a method of removing CYA from pools that involves the use of melamine. Upon addition of melamine to the pool water, a melamine-cyanuric acid complex (“melamine cyanurate”) precipitates from the water and is then removed from the pool by vacuum or filtration. Optionally, a flocculating agent may be used to assist in the removal of the precipitated material. This method of removing CYA is similar to many of the commercially available turbidity tests to measure CYA levels in swimming pools, albeit on a larger scale.

An undesired problem encountered with the use of melamine to remove CYA, particularly in commercial-sized pools, is the development of a green color in the pool's water. While the green color will generally fade within one to two weeks, it is unsettling to pool users and discourages pool use in addition to possibly leading to pool closure by health officials. Both are particularly problematic for commercial pools. Although the “green water” problem is often believed to be caused by metal complexes in the water, even the addition of large amounts of common metal chelating agents such as HEDP (1-hydroxethylidene-1,1-diphosphonic acid) are ineffective in combating the problem.

As a result, there is a need for an improved method and kit to remove CYA from pool water that eliminates the known “green water” problem associated with the use of melamine.

### SUMMARY OF THE INVENTION

The present method provides a solution to the “green water” problem encountered when using melamine to reduce CYA levels in pool water. Although the exact nature and cause of the “green water” problem has not been identified, we have now found that the use of a reducing agent to remove the pool's chlorine will prevent, correct or minimize the “green water” problem depending on when the reducing agent is added.

Accordingly, in one aspect of the present invention there is provided a method for reducing CYA levels in pool water containing chlorine, the method comprising the steps of:
(a) adding a reducing agent to the pool water in an amount sufficient to react with substantially all of the chlorine;
(b) adding a source of melamine to the pool water to cause melamine cyanurate to precipitate; and
(c) removing the precipitated melamine cyanurate from the pool water.

Optionally, the method also includes the step of adding a flocculating agent prior to or during the step of removing the precipitated melamine cyanurate. Further, following removal of the precipitated melamine cyanurate, the water may then be re-chlorinated to the desired level without causing the “green water” effect.

In another aspect of the present invention, a method is provided for reducing CYA levels in pool water containing chlorine to a desired concentration, the method comprising the steps of:
(a) adding a reducing agent to the pool water in an amount sufficient to react with substantially all of the chlorine, where the reducing agent may be selected from sodium sulfite, oxalic acid, ascorbic acid, sodium thiosulfate (anhydrous and hydrates), and hydrogen peroxide, among others;
(b) either prior to, at the same time as, or after the addition of the reducing agent, adding a source of melamine (as a solid or in solution) to the pool water in an amount sufficient to cause enough melamine cyanurate to precipitate so that the desired concentration of CYA remains in the pool water;
(c) adding a flocculating agent to the pool water, wherein the flocculating agent may be selected from cationic flocculants (such as, polyimides, polyacrylates or polyaluminum chlorides), among others; and
(d) removing the precipitated melamine cyanurate from the pool water.

In a further aspect, the present invention provides a kit for use in the reduction of CYA levels in pool water containing chlorine, the kit comprising:
(a) a reducing agent capable of neutralizing chlorine in water;
(b) a source of melamine; and
(c) instructions outlining a method for the removal of CYA from the pool water comprising the steps of:
   i. adding the reducing agent to the pool water in an amount sufficient to react with substantially all of the chlorine;
   ii. adding the melamine to the pool water to cause melamine cyanurate to precipitate; and
   iii. removing the precipitated melamine cyanurate from the pool water.

Optionally, the kit may also include a flocculating agent and the instructions outline a method that includes the step of adding the flocculating agent prior to the step of removing the precipitated melamine cyanurate. Further, the method may also include the step of re-chlorinating the pool water to a desired level following removal of the precipitated melamine cyanurate.

### DETAILED DESCRIPTION OF THE INVENTION

The use of melamine to reduce the CYA concentration in pool water is well known and is the basis of commercial products (e.g., PACIFI CLEAR™ Cyanuric Acid Remover (manufactured by All Chem Industries, Corsicana, Tex.)). However, a known problem with the use of melamine in the removal of CYA, particularly in large and commercial-sized pools, is the temporary discoloration of pool water, which turns green during the CYA removal process. This discoloration typically lasts for 1 to 2 weeks.

In a first aspect of the present invention, a method is provided for reducing CYA levels in pool water without the resultant green color. The method includes the following steps:
(a) adding a reducing agent to the pool water in an amount sufficient to react with substantially all of the chlorine;
(b) adding a source of melamine to the pool water to cause melamine cyanurate to precipitate; and
(c) removing the precipitated melamine cyanurate from the pool water.

While the steps of this method have been listed showing the addition of the reducing agent followed by the addition of the melamine, it will be understood that the order of these two steps is not crucial to the method described herein. Addition of the reducing agent prior to the addition of melamine will prevent the water from turning green during the CYA removal process, but a similar end result may also be achieved by first adding the melamine and then adding the reducing agent, following which the intermediate green color is removed. A further alternative is the addition of the reducing agent and the melamine at the same time.

After the steps of the method have been carried out and the precipitated melamine cyanurate has been removed, the pool water may be chlorinated to the desired level using standard chlorination methods and products. The swimming pool is then ready for use again without the typical green discoloration encountered if a reducing agent is not used.

While any reducing agent that is capable of degrading the chlorine in the water is suitable for use in the present method, preference is given to those reducing agents that are approved for use in swimming pools. Examples of such preferred reducing agents are sodium sulfite, oxalic acid, ascorbic acid, sodium thiosulfate (anhydrous and hydrates), and hydrogen peroxide. In order to avoid adding excess amounts of the reducing agent to the pool water, the chlorine level of the water can first be determined using standard test methods known in the art. The reducing agent may then be added in an amount determined to be sufficient to react with substantially all of the chlorine in the pool water but preferably not so much as to have excessive levels of reducing agent remaining in the water (so as to reduce the need to add excessive levels of the chlorinating agent when rechlorinating the pool). The actual amount of reducing agent will vary depending on the reducing agent used and the concentration of free chlorine in the pool. For example, 4.5 lbs of sodium thiosulfate pentahydrate will remove 6 ppm available chlorine from 10,000 gal pool water or 2 ppm available chlorine from 30,000 gal pool water.

In the circumstance where the reducing agent is added to the pool water after the melamine has been added (that is, following generation of the “green water”), measurement of the chlorine level is not required and the amount of reducing agent added is determined by adding the reducing agent in incremental portions until the green colour dissipates.

The amount of CYA to be removed from the pool water is determined by testing the pool's water, for example, by using a standard CYA test kit. In general, 1 pound (454 grams) of melamine is added per 10,000 gallons (37,850 litres) of water to reduce the CYA concentration by approximately 12 ppm. Alternatively, the amount of melamine to be added to any pool can be calculated using the following formulae:

$$\begin{matrix}Amount ( lb ) melamine = \frac{( ppm CYA to be removed ) ( pool volume ( gal ) )}{( 1.17 \times {10}^{5} \frac{gal}{lb} )} & ( I ) \\ Amount ( g ) melamine = \frac{( ppm CYA to be removed ) ( pool volume ( L ) )}{( 977 \frac{L}{g} )} & ( II )\end{matrix}$$

The resulting precipitated solid (melamine cyanurate) that is formed following the addition of melamine to the pool water may be removed by any method capable of removing fine solids from pool water. Preferred methods are the use of an external vacuum system (preferred for precipitated solids on the pool bottom) and/or the pool's filtration system (preferred for the removal of suspended particulate). Owing to the large of amounts of melamine cyanurate precipitate formed during the CYA removal process, use of the pool's filtration system should be monitored and emptied as required to maintain function.

In order to aid in the removal of the precipitated melamine cyanurate, a flocculating agent (a single flocculating or a mixture of one or more flocculating agents) may be added to the pool water. Flocculating agents typically used in aiding in the removal of solids from bodies of water (clarification), such as pools and ponds, include anionic, cationic or nonionic polymers (e.g., poly(styrene sulfonate), poly(diallyldimethylammonium chloride) and poly(ethylene oxide), among others) and inorganic compounds (e.g., bentonite clays, ferric hydroxide, alum (aluminum sulphate), and polyaluminum chlorides). Preference is given to cationic flocculating agents, for example, cationic polymers (e.g., polyimides and polyacrylates) and cationic inorganic compounds (e.g., alum and polyaluminum chlorides). Ideally, the flocculent is NSF (National Sanitation Foundation, Ann Arbor, Mich.; www.nsf.org) approved for use with drinking water in order to minimize potential safety or exposure issues. The choice and amount of flocculating agent to be added will vary based upon the pool conditions and the nature of the melamine cyanurate formed, the filtration/vacuum system used, the flocculating agent used, and the speed in which it is desired for the precipitate to be removed. As an example, 64 fl. oz. of SUMACHLOR 50 (Summit Research Labs, Flemington, N.J.), an aluminum chlorohydrate (polyaluminum chloride) flocculent, has been found adequate to flocculate up to 15 lbs of melamine cyanurate (resulting from 7.5 lbs melamine addition).

In a second aspect of the present invention, a kit is provided for use in the reduction of CYA levels in pool water containing chlorine. The kit comprises:
(a) a reducing agent;
(b) a source of melamine; and
(c) instructions outlining a method for the removal of CYA from the pool water comprising the steps of:
   i. adding the reducing agent to the pool water in an amount sufficient to react with substantially all of the chlorine;
   ii. adding the source of melamine to the pool water to cause melamine cyanurate to precipitate; and
   iii. removing the precipitated melamine cyanurate from the pool water.

The method of the present invention is illustrated in the following non-limiting descriptions of pilot and field testing that was undertaken during the development of the present method. It will be apparent to the skilled reader that various alterations to the method, including but not limited to, the reagents used, the quantity in which the reagents are used, the manner in which they are added, and the manner in which the precipitated material is removed, may be made when using the method and kit of the present invention.

### Pilot Testing

A pilot test of a swimming pool was carried out by filling a white (to facilitate the observation of colour changes), 5 gal (18.9 L) pail equipped with a recirculation pump and filter to simulate a swimming pool with water from a swimming pool with a high (˜120 ppm) CYA concentration. Melamine (1 g) was added to remove 50 ppm CYA, with the precipitated melamine cyanurate being removed by the filtration system. The following day, the water in the pilot pool had turned green, and remained green following the addition to HEDP (5 doses of 1 mL (1.4 g), 60% active HEDP over the course of two days). Based on the failure of the HEDP to remove the green color from the water, the chlorine (2 ppm) was neutralized by adding 0.12 g of sodium thiosulfate pentahydrate. Following addition of the sodium thiosulfate, the green color of the water immediately faded. Additional melamine (1 g) was added to the water in order to remove a further 50 ppm CYA without the water becoming green.

The pilot test was repeated without the use of HEDP in order to confirm that its presence did not affect the results. After confirming that HEDP was not required in order to remove the green color from the water, sodium hypochlorite was added to the water to produce 10 ppm of free chlorine without the recurrence of the green color.

A third pilot test was conducted wherein the chlorine was neutralized with sodium thiosulfate (0.12 g) prior to adding 1 g melamine to remove 50 ppm CYA. In this test, the pool water remained colorless throughout, and following, the treatment process even when the free chlorine levels were restored to level that would occur in a commercial pool.

### Field Testing

Following the successful pilot lab study, a field test of the 10,000 gal (37,850 L) pool that was the source of the test sample water was undertaken. First, sodium thiosulfate (0.5 lb (0.23 kg)) was added to remove the 2 ppm free chlorine. After verifying by testing that the chlorine had been completely neutralized, 4.5 lbs (2 kg) of melamine, the amount required to remove about 50 ppm of CYA, was introduced through the skimmer with the pump system operating. The pool immediately became milky white, but the water otherwise remained colorless. Owing to the slow rate of settling of the precipitated melamine cyanurate, its removal was assisted with the aid of a flocculating agent (1 quart of a 20% mixture of BUFLOC® 5040, a polyimino manufactured polymer manufactured by Buckman Laboratories, Memphis, Tenn.). After 24 hours of filtering, resulting in pool water that was clear and colorless, the chlorine level was taken up to 10 ppm and a CYA reduction of 50 ppm was verified through standard test methods. In the following days, no color change was observed in the pool water.

In a second field test, a 25,000 gal (96,875 L) pool containing greater than 90 ppm CYA and a higher than normal chlorine level (5-10 ppm available chlorine) was treated according to the present method. After partial de-chlorination (4.5 lbs sodium thiosulfate pentahydrate to neutralize 2-3 ppm chlorine), melamine (3.75 lbs) was added to reduce the CYA level by approximately 20 ppm, following which the water immediately became milky. After operating the pump for 1 hr, SUMACHLOR 50 (1 qt), an aluminum chlorohydrate (polyaluminum chloride) flocculent manufactured by Summit Research Labs, Flemington, NJ, was added and the pump run for an additional 2 hours before being shut down. By this time, the pool water had turned dark green. On the morning of the following day, the pool water had shifted to a yellow-brown color and the majority of the solid precipitate had settled to the bottom of the pool. Testing confirmed the presence of chlorine (5 ppm) in the water. Further sodium thiosulfate was added to remove the remaining free chlorine, with the pool pump being operated to assist in distribution. By evening, the water was light green; however water circulation was limited since the filter was not serviced at this time. The following morning, the filter was serviced and vacuuming of the pool removed all of the settled particles. With the pump system once again in operating condition, proper circulation of the water completed the chlorine neutralization process and the pool water became colorless. Testing confirmed 0 ppm chlorine. The pool was then purposely re-chlorinated to a high level (10 ppm) ppm without color change of the water.

1. A method for reducing cyanuric acid levels in pool water containing chlorine, the method comprising the steps of:
(a) adding a reducing agent to the pool water in an amount sufficient to react with substantially all of the chlorine;
(b) adding a source of melamine to the pool water to cause melamine cyanurate to precipitate; and
(c) removing the precipitated melamine cyanurate from the pool water.

2. The method of claim 1, wherein the amount of reducing agent added is sufficient to react with all the chlorine.

3. The method of claim 1, wherein the step of adding the source of melamine is carried out after the reducing agent has reacted with substantially all of the chlorine.

4. The method of claim 3, further comprising the step of adding a flocculating agent prior to or during the step of removing the precipitated melamine cyanurate.

5. The method of claim 1, wherein the step of adding the source of melamine is carried out prior to the step of adding the reducing agent.

6. The method of claim 5, further comprising the step of adding a flocculating agent prior to or during the step of removing the precipitated melamine cyanurate.

7. The method of claim 1, wherein the source of melamine and the reducing agent are added at the same time.

8. The method of claim 7, further comprising the step of adding a flocculating agent prior to or during the step of removing the precipitated melamine cyanurate.

9. The method of claim 1, wherein the reducing agent is selected from the group consisting of sodium sulfite, oxalic acid, ascorbic acid, sodium thiosulfate (anhydrous and hydrates), and hydrogen peroxide.

10. The method of claim 9, wherein the reducing agent is a sodium thiosulfate.

11. The method of claim 4, wherein the flocculating agent is a cationic flocculating agent.

12. The method of claim 11, wherein the flocculating agent is a polyimide, polyacrylate or polyaluminum chloride.

13. A method for reducing cyanuric acid levels in pool water containing chlorine to a desired concentration, the method comprising the steps of:
(a) adding a reducing agent to the pool water in an amount sufficient to react with substantially all of the chlorine;
(b) either prior to, at the same time as or after the addition of the reducing agent, adding a source of melamine to the pool water in an amount sufficient to cause enough melamine cyanurate to precipitate so that the desired concentration of cyanurate remains in the pool water;
(c) adding a flocculating agent to the pool water; and
(d) removing the precipitated melamine cyanurate from the pool water.

14. The method of claim 13, wherein the reducing agent is selected from the group consisting of sodium sulfite, oxalic acid, ascorbic acid, sodium thiosulfate (anhydrous and hydrates), and hydrogen peroxide.

15. The method of claim 13, wherein the flocculating agent is a cationic flocculating agent.

16. The method of claim 13, further comprising the step of adding a source of chlorine to the pool water after the precipitated melamine cyanurate has been removed.

17. A kit for use in the reduction of cyanuric acid levels in pool water containing chlorine, the kit comprising:
(a) a reducing agent;
(b) a source of melamine; and
(c) instructions outlining a method for the removal of cyanuric acid from the pool water comprising the steps of:
i. adding the reducing agent to the pool water in an amount sufficient to react with substantially all of the chlorine;
ii. adding the source of melamine to the pool water to cause melamine cyanurate to precipitate; and
iii. removing the precipitated melamine cyanurate from the pool water.

18. The kit of claim 17, further comprising a flocculating agent and wherein the method further includes the step of adding a flocculating agent prior to or during the step of removing the precipitated melamine cyanurate.

19. The kit of claim 17, further comprising a source of chlorine and wherein the method further includes the step of adding the source of chlorine to the pool water after the precipitated melamine cyanurate has been removed.

20. The kit of claim 17, wherein the reducing agent is selected from the group consisting of sodium sulfite, oxalic acid, ascorbic acid, sodium thiosulfate (anhydrous and hydrates), and hydrogen peroxide, and the melamine is provided as a solid or solution.
